(19) United States
(12) Patent Application Publication
(10) Pub. No.: US 2007/0120432 A1
(43) Pub. Date: May 31, 2007

(54) Axial magnetic cam

(76) Inventors: David R. Vaden, Knoxville, TN (US); Johnny D. Long, Knoxville, TN (US)

Correspondence Address: David R. Vaden, 1717 West Forest Blvd., Knoxville, TN, 37909, US

(21) Appl. No.: 11/602,000

(22) Filed: Nov. 20, 2006

Related U.S. Application Data
(60) Provisional application No. 60/739,601, filed on Nov. 25, 2005.

(51) Int. Cl. H02K 7/06; H02K 49/00

(52) U.S. Cl. 310/80; 310/103

(57) ABSTRACT

An axial magnetic cam comprising at least one of a first permanent magnet element supported for rotational motion along an axis provides a continuous, circular magnetic field area path and work-space wherein said path includes a magnetic incline. At least one of a second permanent magnet element having a magnetic field is supported for reciprocating motion within operational proximity of the at least one first magnetic element; wherein said reciprocating motion is substantially parallel with said output axis. The at least one of a first magnetic element. and the at least one of a second reciprocating magnetic element provide a constant magnetic force there between without field cross-over, pass-by, circumvention, or disconnect and without contact of said elements; wherein one continuously follows or actuates the other in response to a motive force; thus greatly reducing or eliminating friction, wear, noise, and complexity. Embodiments of the present invention may be constructed to accommodate pumps, motors, and any type of Stirling cycle engine, including single and multi-cylinder configurations; may provide single, dual, or multiple working surfaces that are coaxial, in-line, opposed, or adjacent; and may provide selectable stroke, dwell, and phase angle therein. A reciprocating magnetic element may be attached to a push rod, piston, yoke, diaphragm, bellows, valve, actuator, or other type element or member.

### CROSS REFERENCE TO RELATED APPLICATIONS

This application claims the benefit of U.S. Provisional Application No. 60/739,601, filed Nov. 25, 2005.

### STATEMENT REGARDING FEDERALLY SPONSORED RESEARCH OR DEVELOPMENT

Not Applicable.

### BACKGROUND OF THE INVENTION

1. Field of Invention

The invention relates generally to friction-based mechanical swash plates, wave cams, and structures sometimes referred to as cylindrical or barrel cams for power and motion conversion between rotational and reciprocating elements and relates generally to magnetic motion conversion devices as known in the art. More specifically, the invention relates to an axial magnetic cam that converts rotational and reciprocating motion without physical contact between the rotational and reciprocating magnetic elements.

2. Description of the Related Art

There are numerous mechanical swash plates, wave cams, and barrel cam devices in the prior art for converting between rotational and reciprocating linear motion and such have been used in conjunction with pumps and Stirling cycle engines along with other devices. Typically in mechanical swash plate designs push rods, connecting links, yokes, and cantilevered bearings reciprocate along an axis parallel with the output axis. A planar or curvilinear circular plate concentric with a shaft provides an inclination angle and is fixedly attached or adjustably attached to the shaft. Reciprocating pistons are commonly engaged with the swash plate by push rods having slipper pads, slide bearings, or roller bearings that contact the plate to provide the motion conversion between reciprocating and rotational structures. Moreover, cylinder or barrel cam designs are typically constructed with a cam slot having an inclination angle along the perimeter of a cylinder with dual contact surfaces that may be viewed as two axially spaced swash plate or wave cam surfaces that form the cam cylinder upper and lower slot surfaces. Push rods or pistons with cantilevered bearings follow the cam groove upper and lower faces formed by two axially spaced plate surfaces. Such friction-base devices are known to suffer large mechanical losses and common drawbacks of wear, stress, and noise. Due to the inherent physical contact, mechanical arrangements, and geometries common load and stress points require well lubricated bearings and slides along with engineered strain tolerant materials that are expensive, bulky, and complex. Also, mechanical methods for large loads exhibit wear, skidding, slapping, and noise, along with problems of dissipating heat generated by the mechanical contact of slides, rollers, or bearings loaded in constant contact along the plate or cam surfaces. Typically a load against single or multiple push rods, bearings on both sides of a plate, or bearings between two plate surfaces are intended to maintain constant pressure against the plate to prevent mechanical slapping while also providing return means for pistons. Complex designs have required that bearing assemblies be pre-loaded within critical tolerances and limited space, putting a large demand on small bearing surfaces and it has been given to the field of tribology to analyze wear rates and to predict the useful life of these friction-based mechanisms. After a period of use and wear, in both wet and dry crankcase systems, these designs develop excessive noise levels and suffer mechanical failure. Even the best designs suffer from the problems mentioned along with additional issues such as weight and difficulty in scaling to various sizes. Examples of friction-based devices in the prior art areas follows: U.S. Pat. No. 3,385,051; U.S. Pat. No. 3,407,593; U.S. Pat. No. 4,996,953; U.S. Pat. No. 5,442,913; U.S. Pat. No. 5,533,335; U.S. Pat. No. 6,487,858; U.S. Pat. No. 6,701,709; and U.S. Pat. No. 7,043,909.

Aside from strictly mechanical devices, there are also numerous devices in the art for conversion between rotary and reciprocating motion or force that utilize magnetic fields. Due to the availability and substantial cost reduction of high energy-product permanent magnets such as neodymium and samarium cobalt, such magnets are now finding use in numerous applications including magnetic motion conversion devices wherein various types of mechanical motion may be converted without physical contact and thus with a potential for great reductions in mechanical losses. These materials are also very dense and can withstand considerable loads. Non-contact, linear and rotary motion conversion represents a departure from friction based devices, moving beyond a simple magnetic coupling between shafts or magnetic gears by converting two different types of motion directly and efficiently. The prior art, however, has not shown progress in this field and devices have not found broad usage.

There are examples in the prior art that show attempts to efficiently convert rotary and reciprocating motion by utilizing permanent magnets. Most are not reversible. Typically such devices make use of both the attracting and repelling forces between fields or use only attraction forces. Usually a reciprocating magnet is actuated between two positions to alternately attract and repel step-wise increments of a symmetric rotor, providing intermittent proximity with changing fields between concentrically spaced magnets to cause rotation. Because of the: changing fields, the forces required in such devices produce positions of disconnect or inherent cogging positions and even the few devices that attempt to balance or design around the problem are required to provide a complete flux-linkage disconnect, circumvention of adverse fields, or crossovers between a reciprocating magnet and alternating field sections of a rotor, otherwise excessively complex schemes have been employed. Such devices have shown efficiency losses that outweigh their advantages and most rely solely on the field strength of magnets for torque.

U.S. Pat. No. 4,196,365, issued to Presley; Apr. 1, 1980, entitled “Magnetic Motor Having Rotating and Reciprocating Permanent Magnets”, discloses a flat rotating disc with three separately positioned magnets attached at 120 degree intervals about the face of the disc. A bracket pivotally mounted and having fourth and fifth magnets attached are aligned to alternately repel the first, second, and third spaced apart magnets on the rotating disc. A solenoid linking the pivoting bracket in combination with a timing cam and electrical switch actuate the bracket's precisely timed reciprocating magnets into repelling positions as each of the three rotating magnets passes top dead and bottom dead centers. By this particular arrangement of magnets the device operation depends entirely on the field strength of the magnets for their displacement, having no other leveraging or displacement aspect, and a reciprocating magnet is required to move toward and away from the disc surface magnets. The device must be perfectly timed for each interval of intermittent proximity where a flux linkage disconnect is required between the magnet sections and an adequately changing air gap provided by the bracket motion must allow the sequence of each rotating magnet to pass by a top dead or bottom dead center position and continue to positions where a reciprocating magnet is assumed to reach a “rest position”. Although not mentioned by the inventor, severe cogging occurs in the blank spaces or “rest position” between the repelling magnet field segments so disposed. In the blank sections reciprocating magnets seek attraction alignment in plane and between the three magnets on the disk at each reciprocating excursion where a considerable force of attraction occurs and thus “cogging” along the discontinuous magnetic surface, resulting in significant power losses.

U.S. Pat. No. 4,011,477, issued to Scholin; Mar. 8, 1977, entitled “Apparatus Using Variation in Magnetic Force to Reciprocate A Linear Actuator”, discloses an apparatus for converting the variation in magnetic force between. two magnets, one rotating and one non-rotating, into reciprocating linear motion. Alternating attraction and repelling forces between the two magnets reciprocate an actuator shaft. The device produces cogging positions due to magnetic field switching and relies solely on the field strength of the magnets.

U.S. Pat. No. 3,355,645, issued to Kawakami et.al., Nov. 28, 1967, entitled “Constant Speed Electric Motors Including a Vibrating Magnetic Drive”, discloses a motor rotor having a plurality of equally spaced bar magnets and a stator that consists of a vibrating member carrying a magnet on its free end. The rotor is caused to rotate by alternating forces of attraction and repulsion between the several magnets. The device requires that rapid and critical balance positions be achieved in the operation to avoid cogging at magnetic. field cross-over intervals and for each vibrational amplitude of motion.

U.S. Pat. No. 4,600,849; issued to Lawson et. al., 1986; entitled “Fluid-Activated Motor Having Magnetic Propulsion”, discloses a motor that employs permanent magnet forces. Two axially-stacked hollow, cylinder sections form a stator and each cylinder section is comprised of at least two arc-shaped magnetic field sections having alternating pole faces along its circular path or circumferential track. Reciprocating rotor magnets are precisely controlled and. timed. by a mechanism to switch and cross-over tracks of alternating fields segments so that the attracting field of a rotor magnet follows the off-set attracting field segments between the two tracks. Torque is produced along the length of each circular working segment by mutually perpendicular fields until the rotor magnet reaches the end of each segment where it confronts the barrier of an opposite field and is required to instantaneously reciprocate out of the way and around it by means of a mechanical controlling actuator mechanism and switch tracks within a short cross-over position, otherwise rotational motion would stop. At each cross-over position there is no torque provided as the rotor magnet is required to quickly circumvent the opposing field in its path by reciprocation at the exact sequence of field changing. All torque produced by this device relies entirely on the field strength of the magnets as no other displacement aspect or force is provided. Also, for the sake of stability at high rotational speeds resulting in the need for even faster cross-overs, a fixed mechanical cam plate and follower is used to more positively guide the swinging arms at each cross-over position. Moreover, if the device were used for reverse operation, a mechanical cam and follower would certainly be required to provide the track switching because there is no other displacement aspect in the design. If a rotor magnet reached an end point of a segment without being switched it would abruptly stop at the opposing field. Further, although rotational speed is supposedly controlled by a multiported valve block, the device will only rotate as fast as the magnetic field strength will of itself provide along with how fast mechanical track switching can be performed because the rotor magnet only performs work when it is standing still and attracting the length of each track segment.

The prior art does not show any examples of non-contact permanent magnet axial cams, swash plates, wave cams, or barrel cams.

There has been a continuing need and objective in the art of motion conversion for improvements and alternatives that offer greater wear resistance and reduced friction while minimizing lubrication requirements. These two competing objectives and concerns have become most prominent, for example, in designs for Stirling cycle engines, pumps, thermoacoustic devices, and power generators where there have been unavoidable trade-offs between choices of low friction and durability or greater power factors. The present invention is an enabling technology that overcomes problems of the prior art by providing a non-contacting leverage and displacement aspect independent of the field strength of the magnets and provides efficient and robust motion conversion at any scale without field crossing, intermittent proximity, cogging, or circumvention of an adverse field.

### BRIEF SUMMARY OF THE INVENTION

An axial magnetic cam comprising at least one of a first permanent magnet element supported for rotational motion along an axis, provides a continuous, circular magnetic field area path and work-space wherein said path includes a magnetic incline that provides non-contact leverage or displacement. At least one of a second permanent magnet element or assembly having a magnetic field and selectable shape is supported for reciprocating motion within operational proximity of the first magnetic element or assembly; wherein said reciprocating motion is substantially parallel with the output axis. The at least one of a first magnetic element and the at least one of a second magnetic element provide a constant magnetic force there between without field cross-over or pass-by, without circumvention of an alternate field segment, without magnetic force disconnect, and without contact of said elements; wherein one follows or actuates the other in response to a motive force; thus greatly reducing or eliminating friction, wear, noise, and complexity. Continuous magnetic force between a magnetic cam surface and a reciprocating magnetic element is provided by attraction or repelling forces or a combination thereof without magnetic conflict and solves many of the problems associated with the prior art while providing a simple, light-weight alternative and enabling more compact and scalable designs.

Embodiments of the present invention may be constructed to accommodate pumps, motors, and any type of Stirling cycle engine including single and multi-cylinder configurations; may provide single, dual, or multiple working surfaces that are coaxial, radial, in-line, opposed, grouped, separated, or adjacent; and may provide selectable stroke, dwell, and phase angle. A reciprocating magnetic element may be attached to or integral to a push rod, piston, yoke, diaphragm, bellows, valve, actuator, or other type element or member. Elements of the invention may also be stacked, grouped, or combined variously and may assume various shapes and magnetic axis orientations.

Of special interest and advantage to the present invention is that a constant, field is provided by the magnetic arrangement of the working elements having a magnetic leveraging displacement path and that efficient conversion and non-contact leverage (leverage independent of the magnetic field product) is provided with a great reduction in mechanical losses. For purposes of the specification and the later claims, a magnetic, displacement path, leveraging aspect, or circular magnetic wedge is a magnetic incline greater than zero degrees horizontal and less than ninety degrees vertical included in the continuous circular path of at least one continuous permanent magnet rotational element and causes or enacts displacement of a rotational or reciprocating element. The term “magnetic incline” also represents a change of vertical distance in relation to increasing or decreasing degrees of displacement and is measured from an imaginary flat plane perpendicular to the rotational axis to a magnetic work-space or continuous working points along a magnetic cam surface or profile regardless of magnetic axis orientation or magnetic field combination A magnetic incline provides non-contact leverage, torque, or wedge in relation to the output independent of the field strength of the magnetic elements.

The present invention in most embodiments utilizes the repelling forces between magnetic elements; however, in some embodiments attraction forces or combinations of repelling and attraction forces may be utilized without cross-over, cogging, flux linkage disconnects, or magnetic conflict. By proper selection of magnets and assemblies for a given application, more than needed or substantial power-weight ratios may be achieved. In some application-dependent cases where it is desired to provide fail-safe or redundancy measures, or for other reasons, a mechanical contact device or member, or other magnetic members, may be additionally attached to engage at a preselected limit of magnetic compression or expansion relative to a bounce space or work-space herein described. The bounce space is a non-contact magnetic work-space area or an air gap dimension of compressing, expanding, repelling, attracting, or resisting magnetic force in accordance with magnetic flux density, magnetic element size, surface area, and magnetic field orientation and an area wherein the permanent magnet elements or assemblies do not of themselves physically contact one another in the work-space. Thus, depending on an arrangement or embodiment, a work-space may also include other structures or members, cams or surfaces, bearings or slides. Moreover, while magnetic elements or components provide non-contact operation there between, a mechanical device such as a bearing, slide, or other member may have constant contact with a cam or an intermediate surface while the non-contacting magnetic elements provide return means or provide reduced contact load of the additional mechanical member or cam. Thus, in addition to stand alone embodiments, elements or assemblies of the invention may also operate to assist, provide return means, or reduce friction or load forces in mechanical contact cam systems as known in the art.

In view of the prior art, the numerous unsolved problems, and future requirements for emerging technologies, there is a need for a system of motion and force conversion that meets the challenges and represents a viable alternative to old mechanical systems. The present invention is an enabling technology that overcomes problems of the prior art and provides an efficient and robust means for non-contact motion conversion and friction reduction at any scale. It is therefore an object of the present invention and the various embodiments to solve various problems in the prior art, to minimize friction and mechanical losses, to replace numerous friction-based mechanical devices along with inefficient magnetic motion conversion devices that convert rotary and reciprocating motion, and to provide design engineers with a new tool box of efficient magnetic motion conversion devices.

### BRIEF DESCRIPTION OF THE SEVERAL VIEWS OF THE DRAWINGS

The above mentioned features of the invention will become more clearly understood from the following detailed description of the invention read together with the drawings in which:

FIG. 1 is a side plan view of an embodiment of the invention.

FIG. 2 is a perspective side view and explanatory plan view of an embodiment of the invention with reciprocating push rods and magnetic elements connected to pistons.

FIG. 3 is a side plan view of an alternate embodiment of the invention.

FIG. 4 is a partial explanatory view and example of an alternate embodiment and possible stacking arrangement of the invention.

FIG. 5 is a perspective and explanatory plan view of an alternate embodiment.

FIG. 6 and FIG. 7 are perspective side views of alternate rotational elements and arrangements.

### DETAILED DESCRIPTION OF THE DRAWINGS

While viewing the illustrations and explanatory drawings, it should be understood that particular supporting structures, substrates, or members for connecting magnets or assemblies in many examples are not shown that would nonetheless be practically applied on the basis of known machining practices and loads or stresses for a given or chosen application and that selectable shapes and components may be independent of bonding structure shapes and peripheral or additional structures that may be provided. Further, various bonding methods or magnetic assemblies may be utilized and there are numerous companies who specialize in the production of custom magnetic assemblies. It should further be understood that sizes, shapes, profiles, and spacings are shown for purposes of illustration and may vary substantially. Also, the thickness or the density of a permanent magnet rotational element or assembly may vary, providing a varied amount of magnetic force along a work-space path.

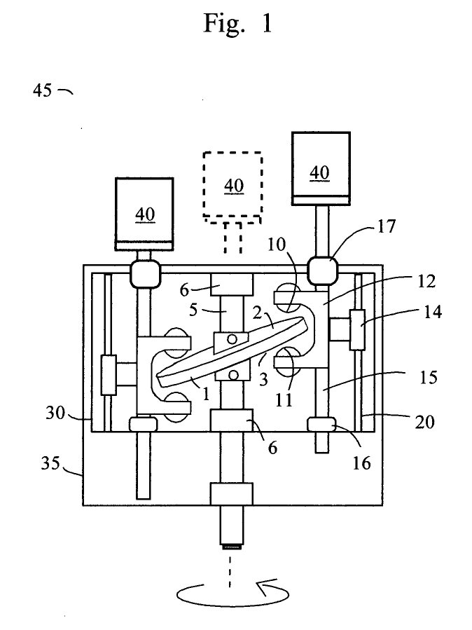

Viewing now FIG. 1, an embodiment of the present invention integral to an engine 45 is shown. The engine 45 has four pistons or displacers 40 connected to push rods 15, each occupying a circular quadrant, although any number and as few as one can be utilized. Each push rod 15 is provided in this case with linear bearings 16 and 17 that may also incorporate seals and serves as support means for reciprocating magnetic elements 10 and 11. Each push rod 15 is rigidly bonded to a yoke assembly 12. Reciprocating permanent magnet elements 10 and 11 are axially spaced and fixed to the yoke assembly with a predetermined spacing distance sufficient to accept the permanent magnet axial cam element 1 there between and maintain an adequate non-contact work-space. The yoke member 12 merely represents a physical connection between the upper and lower reciprocating magnets and may be constructed variously and reciprocating magnet elements are not necessarily required to be cantilevered as shown. For example, a push rod 15 may be attached directly in line with the axis of a reciprocating magnet 10, or various other types of rails, carriages, slides, or bearings may be incorporated. The spacing distance of reciprocating magnets 10 and 11 along with the yoke length is determined by the calculated potential load in relation to the size, working surface area, and mass of the magnetic elements and their non-contact displacement potential. Mechanical touch-down bearings or slides in conjunction with yoke 12 or magnetic surfaces 10 and 11 may be additionally constructed and attached for overload, failsafe, or redundancy considerations. An alternate failsafe method would be to provide a low friction coating or late along the surface areas of the reciprocating magnetic elements and the surface of the axial cam. Additionally attached to the yoke assembly 12 is a yoke alignment guide bearing 14 that slides along the alignment rod 20. In most cases the guide bearing 14 does not carry any load. It simply keeps the magnets in alignment and would not be needed in alternate methods or other linear guide systems as known in the art. It should be understood that there are numerous support means possible for the reciprocating magnets and that there are various linear slides or bearing assemblies that may accomplish the same task.

In the plan view of FIG. 1, piston rod bearings 17 and guide rods 20 are mounted to the housing 30 and a containment housing 35, all of which provide support means in this example for reciprocating magnetic elements 10 and 11. Magnetic elements 10 and 11 reciprocate parallel with the cam axis and output shaft 5 and in this case provide a repelling magnetic field facing the magnetic axial cam upper and lower magnetic surfaces 2 and 3 respectively and without contact of magnetic elements under normal loads. In this example, magnetic elements 10 and 11 are spherical in shape and provide a single repelling magnetic field facing the magnetic cam on each side. Other magnetic orientations, assemblies, and shapes may be utilized and will be discussed. However, in this example a spherical shaped reciprocating element provides a surface area of magnetic flux that closely follows the magnetic cam surface for this embodiment at all angular positions.

Magnetic axial cam element 1, in this drawing having magnetic field surfaces 2 and 3, provides a magnetic incline and is fixed to an output shaft 5 supported for rotational motion through bearings 6, that are mounted in the housing 30. The magnetic cam 1 in this embodiment may be a single disc or ring magnet, a laminated or bonded assembly, plate, or magnetic assembly having a continuous and non-changing circular magnetic field along the operating surface. An operating surface may also be profiled-or contoured to provide a greater working surface area For example, a continuous magnetic trough may be provided along a plate surface to match the facing shape of a reciprocating magnetic element (not shown).

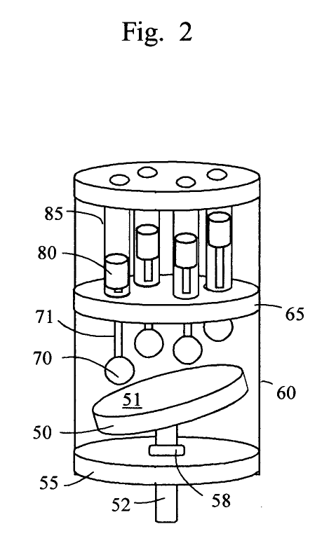

A simplified embodiment and application of the present invention is now shown in FIG. 2. In this plan view, a spherical reciprocating magnet 70 is fixed to push rod 71 that slides through linear guide plate 65 supported further by the base housing 60. Push rods 71 extend further and connect to pistons 80 within cylinders 85. Reciprocating magnets 70 provide a repelling magnetic field facing a magnetic cam element 50 having a magnetic surface 51. The magnetic cam element 50 is supported for rotational motion by a shaft 52 and bearing 58 along with base plate 55. In this example, since a yoke member is not provided connecting a reciprocating magnet on the other side of the cam, an alternate method of return means for a reciprocating element would be utilized. Aside from allowing return by gravity, one method would be the use of mechanical or magnetic return springs; or, depending on the application, pressure differentials within the cylinders 85 may also provide the return means.

In cases wherein only one or two reciprocating magnetic elements are utilized a flywheel fixed to the output shaft can be provided to move the cam beyond vertical top and bottom centers; otherwise, and in most cases a flywheel would not be needed.

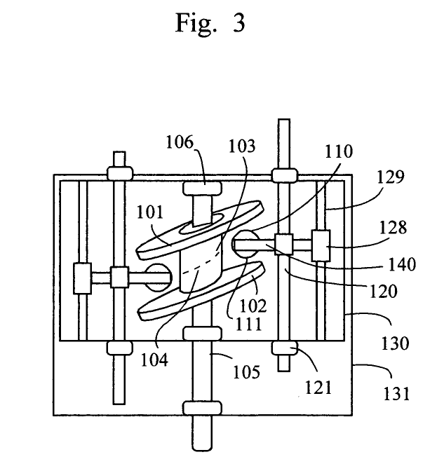

Referring now to FIG. 3, an alternate embodiment of the present invention is shown. Two axially spaced magnetic cam elements 101 and 102 are separated by a cylinder or “barrel” 103 and form what is commonly referred to as a barrel cam slot. In cases of light loads however, 103 may simply be a continuation of the shaft 105 supported by bearings 106. A reciprocating magnetic element has magnetic surfaces 110 and 111 that face and repel the inner surfaces of 101 and 102 respectively and is cantilevered within the slot by connecting member 140. Connecting member 140 extends laterally, secured to the push rod 120, and makes a further connection to alignment bearing 128 that slides along alignment rod 129.

Again, in this view, the push rod 120 and linear bearing 121, along with connecting member 140, alignment bearing 128, and alignment rod 129 provide a support means and linear bearing system for the reciprocating magnetic element although other linear bearing assemblies may be provided to perform the same task. In some cases it would be advantageous and feasible to eliminate the alignment bearing 128 and alignment rod 129. Aside from other mechanical linear guide systems known in the art, another method would be to provide an additional magnetic field, such as a force of attraction, to maintain alignment of the reciprocating element inside the “cam slot”. For example, cylinder 103 may be a ferrous material with sufficient mass to attract the reciprocating magnetic element and maintain its alignment within the slot, or cylinder 103 may be magnetized axially or radially in relation to a polar division designated by dotted line 104, thus holding the reciprocating element in alignment by a force of attraction. Of course this could also be achieved externally to the slot by replacing alignment bearing 128 with an additional magnet (not shown), eliminating alignment rod 129, and providing a non-contact magnetic member adjacently to the additional magnet to maintain alignment, or an external alignment magnet attached to the yoke could be sandwiched between two repelling bar magnets. There are other non-contact, magnetic linear guide systems known in the art that could be utilized in such a construction but for the sake of brevity will not be further discussed.

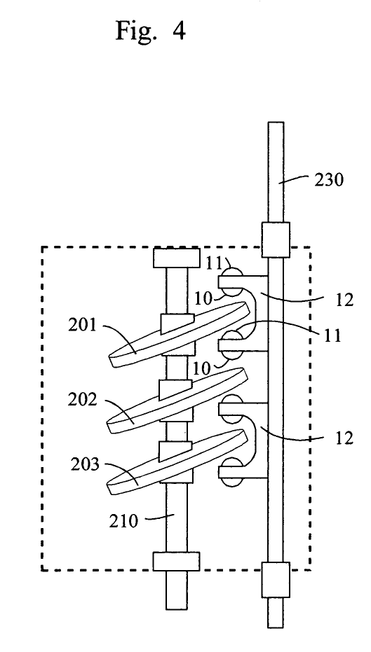

Units may also be stacked along a common output shaft as generally shown now in FIG. 4. In this example, three magnetic cam elements 201, 202, and 203 are coaxially spaced along the common shaft 210. Magnetic pole faces 10 and 11 of reciprocating elements are cantilevered and supported by yokes 12 connected to push rod 230. Repelling forces in this case are applied to both sides of each magnetic cam surface and by stacking in this manner a cumulative magnetic force is achieved. When calculating load potential with the output shaft in a locked rotor state for instance, the force required to cause the pole face of the reciprocating elements to contact the cam element surface is a multiple of the force that would be required in the case of one. This type of stacking in particular applications would allow flexibility in sizing verses force potential. Any number of magnetic cams may be stacked in this manner. Also, cam surfaces may be oriented as singles or pairs in phase shift relation to each other so that reciprocating elements may operate at different phases whether in-line coaxally or adjacently parallel about the cam perimeter. Various and other stacking arrangements may also be utilized and may include combinations with alternate axial magnetic cam shapes.

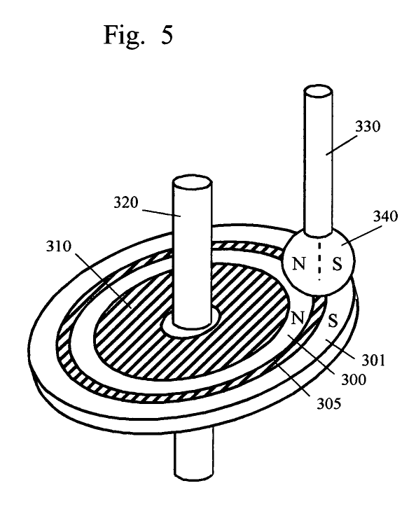

As previously mentioned, it is also possible for the magnetic surf aces and fields to be magnetic assemblies wherein more than one polar field, for instance a north and a south field, combine to form a repelling field surface. A magnetic cam surface may be provided with concentric rings of alternating pole faces in a manner such that magnetic forces of a reciprocating magnetic element would not be required to cross-over or disconnect along a working path. An example and embodiment of such is shown in the explanatory, perspective plan view of FIG. 5. In this embodiment two concentric permanent magnet elements 300 and 301, attached to a support member 310 and shaft 320, are spaced by intermediate member 305 and provide a continuous circular field of north and south poles along a magnetic incline. The two polar fields repel the matching like polar fields of a reciprocating magnetic element 340 attached to a push rod 330. Of course the push rod in this example would need to be restrained from twisting or turning by some type of alignment means such as previously shown and discussed. Intermediate spacing member 305 in this example accommodates the slight change of radial distance that occurs at different angular positions of the shaft and is not necessarily required. Thus the two concentric rings could have direct abutment or be constructed as a one piece magnetic assembly. In addition, a substantially circular path may be shaped to deviate, formed for example as an ellipse to accommodate a variation of radial distance that may occur due a particular embodiment. Also, as previously discussed, the two poles of the rotational element could be profiled in a shaped trough.

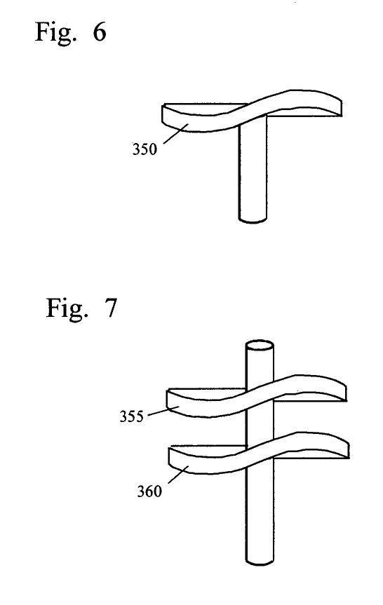

With regard to a magnetic incline provided by at least one permanent magnet rotational element, instead of a magnetic cam surface being planar, a work-space or surface may provide a curvilinear or wave path, an example of which is shown now in FIGS. 6 and 7. A single permanent magnet wave cam element 350 is shown in FIG. 6; and two axially spaced permanent magnet wave cam elements 355 and 360 of FIG. 7 form a curvilinear magnetic cam slot there between. The advantage of a curvilinear magnetic surface or cam slot is that various curvatures and shapes may provide areas of dwell so that a piston, for example, can spend more time at given position during a cycle. Also, alternate embodiments would include combinations of a planar magnetic cam and a curvilinear magnetic cam axially spaced and sharing a common shaft so that two distinct functions may be incorporated in a system and may operate in phase shift relation. Otherwise, of course, multiple curvilinear cam shapes may be stacked and spaced along a common axis.

While there has been described and illustrated herein various embodiments of the invention, it is not intended that the invention be limited thereto. Thus, while reciprocating magnetic elements have been shown to reciprocate along a pure linear path, such element could also be fixed to a pivoting lever. Furthermore, in view of the reversibility of the motion converter and its broad range of applications, use of the term ‘output axis’ or ‘output shaft’ should be read also as input axis or shaft, particularly with respect to the claims. Accordingly, departures may be made from such details without departing from the spirit or scope of applicants general inventive concept.

The disclosure of the invention herein also relates to co-pending application; 60/780,004.

Having thus described the aforementioned invention, we claim:

1. An axial magnetic cam comprising:
at least one of a first permanent magnet element is supported for rotational motion along an axis and provides a continuous, circular magnetic field area path and work-space; wherein said element provides a magnetic incline along said path;
at least one of a second permanent magnet element having a magnetic field is supported for reciprocating motion within operational proximity of said first magnetic element; wherein said reciprocating motion is substantially parallel with said rotational axis;
the at least one of a first magnetic element and the at least one of a second reciprocating magnetic element provide a constant magnetic force there between along said path without field cross-over, circumvention, pass-by, or disconnect, and without contact of said elements; wherein one continuously follows or actuates the other in response to a motive force.

2. The axial magnetic cam of claim 1, further comprising:
at least two of said first permanent magnet elements are provided and are axially spaced along a common rotational axis.

3. The axial magnetic cam of claim 2, wherein:
said at least two axially spaced permanent magnet elements are positioned in phase shift relation.

4. The axial magnetic cam of claim 2, wherein:
said at least two axially spaced permanent magnet elements are axially spaced to form a congruent magnetic slot there between.

5. The axial magnetic cam of claim 1, further comprising:
at least two of said first permanent magnet elements form a magnetic assembly having a common rotational axis and are concentrically disposed along a common plane.

6. The axial magnetic cam of claim 5, wherein:
said at least two radially disposed elements have spacing there between.

7. The axial magnetic cam of claim 1, further comprising:
at least two of said reciprocating permanent magnet elements are provided and are axially spaced along a common axis of reciprocating motion.

8. The axial magnetic cam of claim 7, wherein:
said at least two reciprocating elements have connection means there between.

9. The axial magnetic cam of claim 8, wherein;
a plurality of said at least two reciprocating elements having connection means there between are provided.

10. The axial magnetic cam of claim 1, further comprising:
a plurality of permanent magnet reciprocating elements are disposed about the work-space perimeter of said at least one of a first permanent magnet element.

11. The axial magnetic cam of claim 1, wherein:
said at least one of a first permanent magnet element has a planar shape.

12. The axial magnetic cam of claim 1, wherein:
said at least one of a first permanent magnet element has a curvilinear shape.

13. The axial magnetic cam of claim 12, wherein:
said curvilinear shape has a magnetic area that provides dwell.

14. The axial magnetic cam of claim 1, wherein:
said permanent magnet rotational element is provided by a magnetic assembly having combined fields.

15. The axial magnetic cam of claim 1, wherein:
said reciprocating magnetic element is provided by a magnetic assembly having combined fields.

16. The axial magnetic cam of claim 1, wherein:
said magnetic cam is constructed integrally with a Stirling cycle engine system.

17. The axial magnetic cam of claim 1, wherein:
said magnetic cam is constructed integrally to a pump.

18. The axial magnetic cam of claim 1, wherein:
said magnetic cam is constructed integrally to an electrical generating device.

19. The axial magnetic cam of claim 1, wherein:
said magnetic cam is constructed in conjunction with a friction-based mechanical cam for assistive operation there between.
